(19) United States
(12) Patent Application Publication
(10) Pub. No.: US 2007/0044982 A1
(43) Pub. Date: Mar. 1, 2007

(54) Ebb-and-flow drain and fluid-handling system

(76) Inventor: William N. Mebane, Falmouth, MA (US)

Correspondence Address: William A. Marino, Esq., 34 Depot Ave., Suite No. 2, Falmouth, MA, 02540, US

(21) Appl. No.: 11/216,406

(22) Filed: Aug. 31, 2005

(51) Int. Cl. B23Q 5/00

(52) U.S. Cl. 173/143

(57) ABSTRACT

The present invention provides an ebb-and-flow fluid handling system and drain and tank assembly. The system allows continuous and periodical flushing of the total volume of fluid in a tank, while minimizing turbulence in the tank. The percentage of total volume, and thus the periodicity of flushing, is adjustable. The system can be used to remove solids from a tank, without excessive disturbance of the total contents.

### CROSS-REFERENCE TO RELATED APPLICATIONS

N/A

### STATEMENT REGARDING FEDERALLY SPONSORED RESEARCH

N/A

### REFERENCE TO SEQUENCE LISTING

N/A

### BACKGROUND OF THE INVENTION

1. Field of the Invention

The present invention relates to an ebb and flow drain assembly for fluid tanks. More particularly, it relates to an automated siphon/siphon break system, with an adjustable fluid cycling mechanism.

2. Description of Prior Art

There are many fluid-handling systems that would benefit from the ebb and flow design of the present invention. Fluid handling systems, for example, in the beverage industry may desire to periodically remove solids from fermentations. Additionally, the cell culture systems in the biotechnology industry may desire to remove solids from cultures, without creating significant turbulence in the culture system. Another example includes the aquatic animal husbandry industry, and in particular the husbanding of Xenopus frogs used in biological research.

There are two species of Xenopus frogs that are mainly used in biological research, Xenopus leavis and Xenopus tropicalis. While X. Leavis is much larger then X. tropicalis, they two species share a similar biology. Thus, the care of these frogs is also generally similar.

In their natural environment, Xenopus frogs are found in ponds of stagnant water. Typical temperature is approximately 18.3 degrees C. for X. Leavis and 26 degrees C. for X. tropicalis. Lighting for the frogs is a 12 and 12 hour light/dark cycle.

Successful care of this frog requires recreating the natural surroundings to the greatest extent possible. As aquatic species, the water quality is by far the most important aspect of the husbanded environment, and supplying an adequate water system has proven to be the most difficult and expensive aspect of caring for Xenopus frogs.

Xenopus frogs are absolutely intolerant to chlorine found in most municipal water supplies. Thus, many researchers will let tap water stand for a period of time sufficient to permit the chlorine in the water dissipate. Some municipalities, however, now add Chloramine, which is more stable than chlorine. In such municipalities, the water must be carbon filtered to remove the Chloramine. These procedures are all time consuming and at each water change run the risk of contamination.

To address these problems, many labs maintain their own reverse osmosis systems as a way to provide a reliable source of quality water. While this provides some assurances of water quality, it comes at significant expense. Thus, even in RO systems, there remains a strong desire to minimize water changes in the frog tanks.

In addition to their susceptibility to poor water quality, the Xenopus frogs generate solid waste, which cannot be in close proximity to the frogs if the frog cultures are to remain healthy. In the wild, frogs naturally reside in still, stagnant water where solid waste (their own metabolic by-products) accumulate however, unlike frogs contained in laboratory tanks. Wild frogs are free to reposition themselves away from these accumulations of harmful solids. Accumulation of solid waste products in small aquatic holding environs are usually removed by introducing sufficient water flow to create a capacitance capable of removing the solids. Because the sensitive electrophysiology of the frogs' complex lateral line system, (used to sense movement in water to detect prey). Turbulence and flow must be minimal. Too much flow in the water acts as a constant stimulus on the frogs and can be a source of health compromising stress. Furthermore, too much flow can result in a sickness referred to as gas bubble disease. These physiological factors limit the amount of water flow that can be used to create the capacitance required to remove accumulated solid waste, Thus, a need remains for a fluid handling system that permits the generation of capacitance sufficient to remove the frogs' solid waste without introducing excessive flow or turbulence.

### BRIEF SUMMARY OF THE INVENTION

Many advantages will be determined and are attained by the present invention, which provides an ebb-and-flow drain, a tank assembly with the ebb-and-flow drain and a fluid-handling system using the ebb-and-flow drain. Implementations of the invention may provide one or more of the following features. A system is provided that selectively and periodically flushes a total volume of a tank of fluid. The system cycles between three phases, a “fill phase” (also called the “siphon-break phase”), a “trickle phase” and a “flush phase.” The amount of total volume flushed is adjustable by varying the height of an adjustable siphon-break tube

An embodiment of the invention provides a drain assembly. The drain assembly is comprised of an inner standpipe and an outer housing. The outer housing is placed over the inner standpipe to form an interstitial space, or chamber, between the standpipe and the outer housing. The outer housing has an at least one aperture at the proximal end that connects to a siphon-break tube. The outer housing also has at least one port for fluid communication between the exterior of the outer housing and the interstitial space between the outer housing and the inner standpipe.

In another embodiment, the drain assembly has an adjustable siphon-break tube. The total volume of the flush of the tank can be varied by adjusting the height of the siphon-break tube.

In still another embodiment of the invention, a tank assembly is provided. The tank assembly is comprised of a tank and a drain. The drain of this embodiment is comprised of an inner standpipe; an outer housing, having a proximal and a distal end, which is placed over the inner standpipe to create an interstitial space between the standpipe and the outer housing; the outer housing having an at least one aperture at the proximal end that connects to a siphon-break tube; and the outer housing having at least one port for fluid communication between the exterior of the outer housing and the interstitial space between the outer housing and the inner standpipe. The tank of this embodiment is comprised of a fluid holding reservoir and, optionally, a recessed portion to receive the drain. The tank assembly of this embodiment may also have, at the bottom of the tank, flow-directing channels directed-toward the drain, which helps facilitate the movement of solids toward the drain.

In yet another embodiment, the tank assembly has a fluid return on the bottom of the tank. The fluid return may contain multiple return ports, which may be optionally aligned with the flow-directing channels.

In still yet another embodiment, a fluid-handling system is provided. The fluid-handling system is comprised of comprised of a fill phase, a trickle phase and a flush phase. During the fill phase, the fluid-handling system is equalized with respect to atmospheric pressure and the system begins to fill until the fluid reaches a fluid egress. Upon reaching egress, the system enters the trickle phase, wherein the fluid begins to trickle from the system until the capacity of the egress is exceeded and occlusion forms causing a head pressure to build above the fluid egress. Once the head pressure exceeds the pressure created by the occlusion, the fluid begins to flow, forming a siphon, as the system enters the flush phase. The flush phase ends when the fluid level falls below the level of an opening to atmosphere, breaking the siphon. A total volume of fluid can be flushed from the system depending on the variably adjusted height of the opening of the system to the atmosphere. During the flush phase, the capacitance of the fluid in the system is approximately at least three times the capacitance of the fluid during trickle phase.

The invention will next be described in connection with certain illustrated embodiments and practices. However, it will be clear to those skilled in the art that various modifications, additions and subtractions can be made without departing from the spirit or scope of the claims.

### BRIEF DESCRIPTION OF THE SEVERAL VIEWS OF THE DRAWINGS

The invention is herein described, by way of example only, with reference to the accompanying drawings, wherein:

FIG. 1 shows a sectional view of the tank and drain assembly;

FIG. 2 shows a sectional view of the tank and drain assembly, further showing the optional fluid recycling system;

FIG. 3 shows a sectional view of the fluid-handling system in siphon-break phase;

FIG. 4 shows a sectional view of the fluid-handling system in trickle phase;

FIG. 5 shows a sectional view of the fluid-handling system in flush phase;

FIG. 6 shows a perspective of the tank and drain assembly with fluid flow channels;

FIG. 7 shows the aggregation of solid waste, with the system in trickle phase; and

FIG. 8 shows the elimination of solid waste, with the system in flush phase.

### DETAILED DESCRIPTION OF THE INVENTION

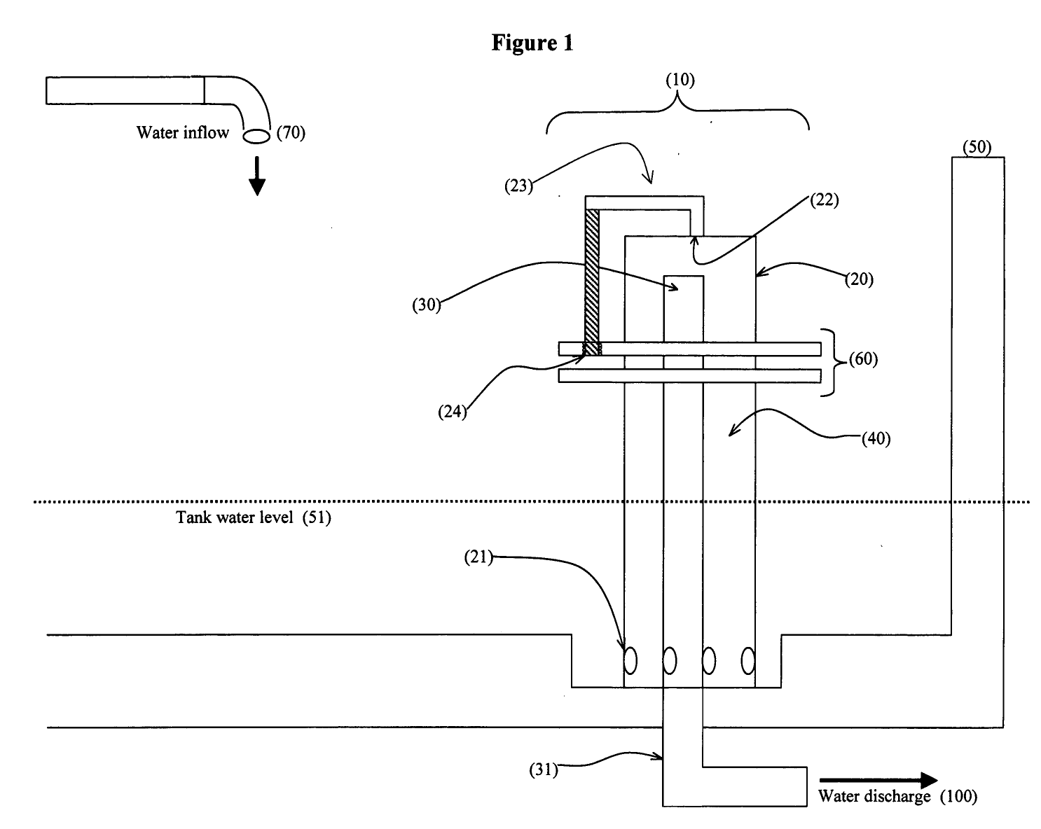

FIG. 1 depicts a sectional view of the ebb and flow siphon drain assembly 10. As shown in FIG. 1, the drain assembly is comprised of an exterior housing 20 and a standpipe 30. When placed over the standpipe 30, the standpipe and exterior housing 20 create an interstitial space 40.

The exterior housing 20 has a proximal end and a distal end. The distal end of the exterior housing has openings 21 for fluid communication between the interstitial space 40 and tank 50 contents. The proximal end of the exterior housing has an opening 22 that attaches to a siphon break tube 23 at a first end. The second end of the siphon break tube 23 has an opening to the atmosphere 24. In a preferred embodiment, the second end of the siphon break tube 23 is attached to a moveable tube holder 60 that can be raised and lowered to varying heights.

The standpipe 30 also has a proximal end and a distal end. The proximal end of the standpipe 30 is open to the interstitial space 40. The distal end of the standpipe 31 passes out of the tank 50 for tank effluent 100.

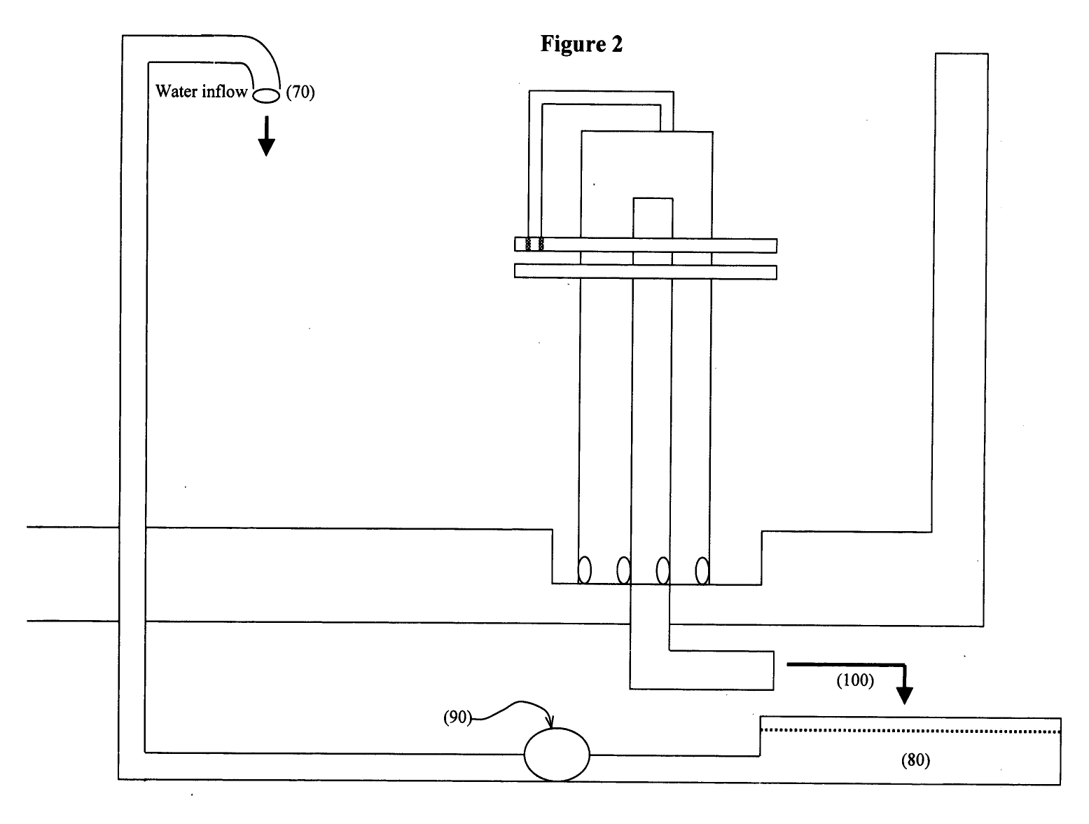

As can be seen in FIG. 2, the ebb-and-flow drain assembly and tank are part of a larger fluid handling system. This system includes a fluid return 70, an effluent collection reservoir 80, a pump 90 and a means for processing the effluent 100.

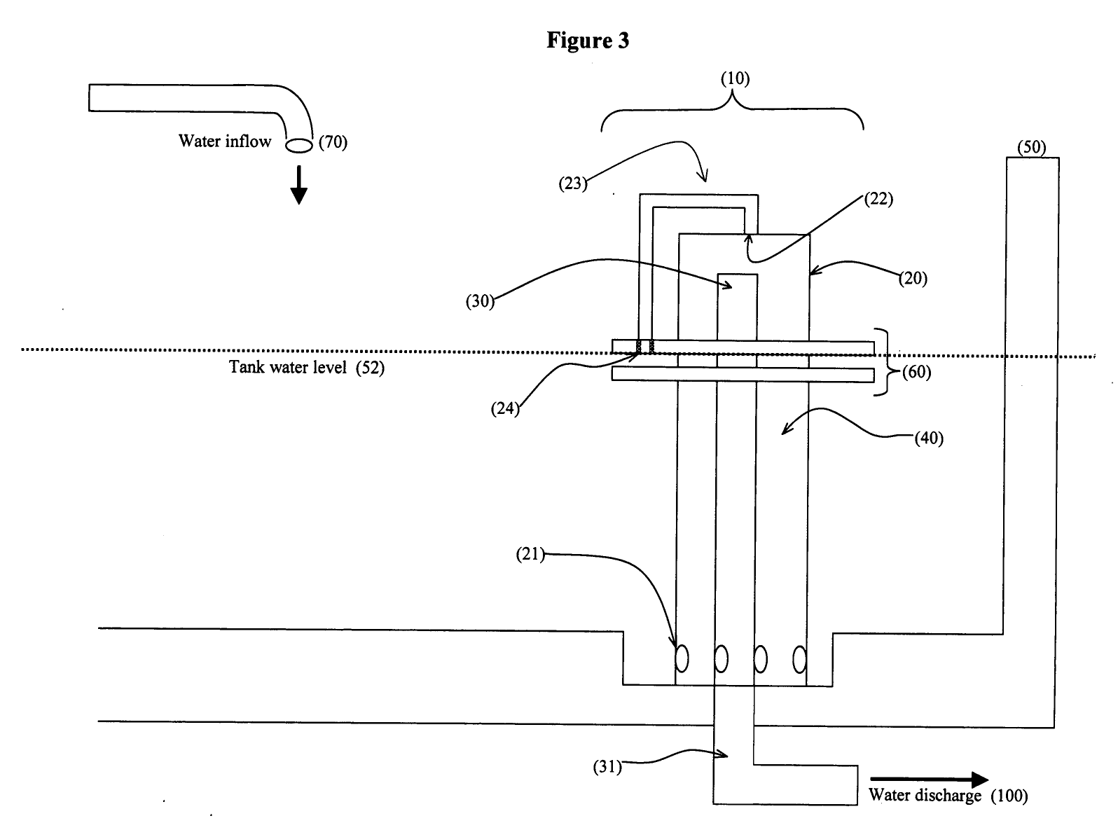

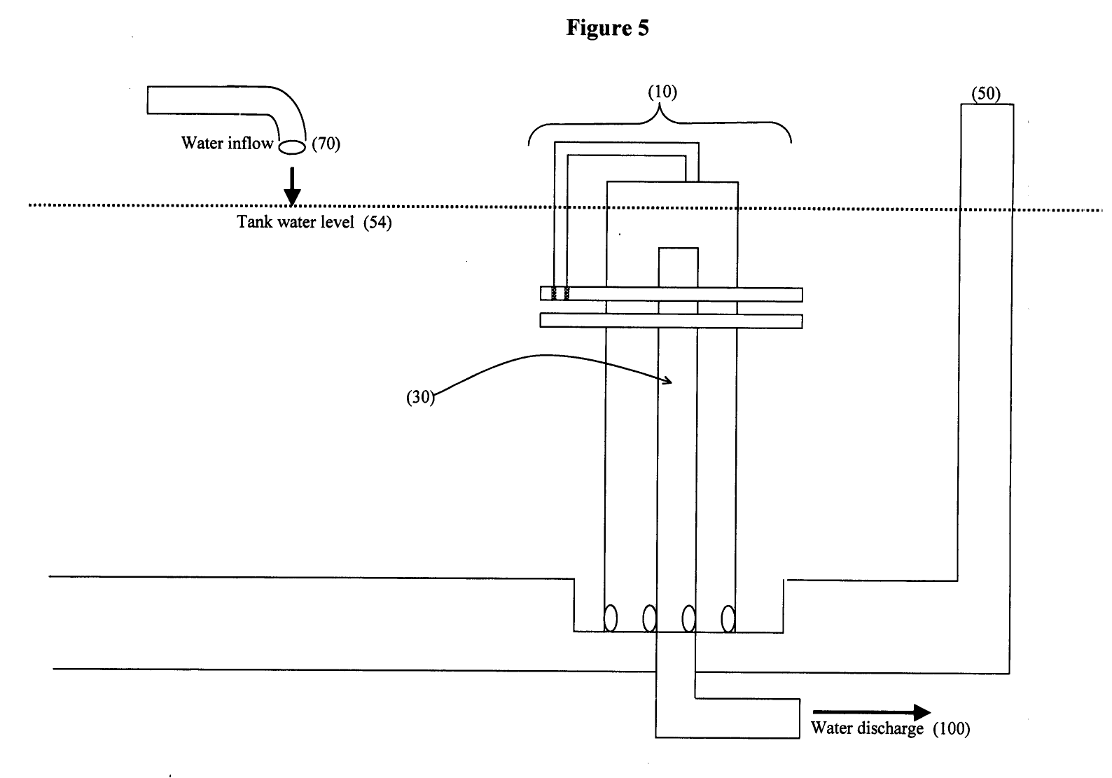

In operation, as shown in FIGS. 3, 4 and 5, the tank 50 contains a fluid 51 that ebbs and flows in accordance with the design of the present invention. The ebb and flow function of the drain has three phases, “fill phase” (also known as “siphon break phase),” “trickle phase” and “flush phase.” Each of these phases is shown in FIGS. 3, 4 and 5, respectively. They are described below beginning with the fill phase, but the process is cyclical the order of the description is not meant to impart any necessary order of the steps.

As shown in FIG. 3, in the fill phase the fluid level 52 of the system drops to the level of the siphon-break tube opening 24. With the fluid at siphon break level, the pressure inside the interstitial space 40 equals that of the ambient atmosphere. At the end of siphon break, the fluid level begins to rise because the fluid level at siphon break is lower that the standpipe 30 opening. The tank, therefore, begins to fill. As the tank fills, fluid from the tank enters the interstitial space 40 through the openings in the distal end of the exterior housing 20. The fluid level inside the tank and the fluid level inside the interstitial space are essentially equal.

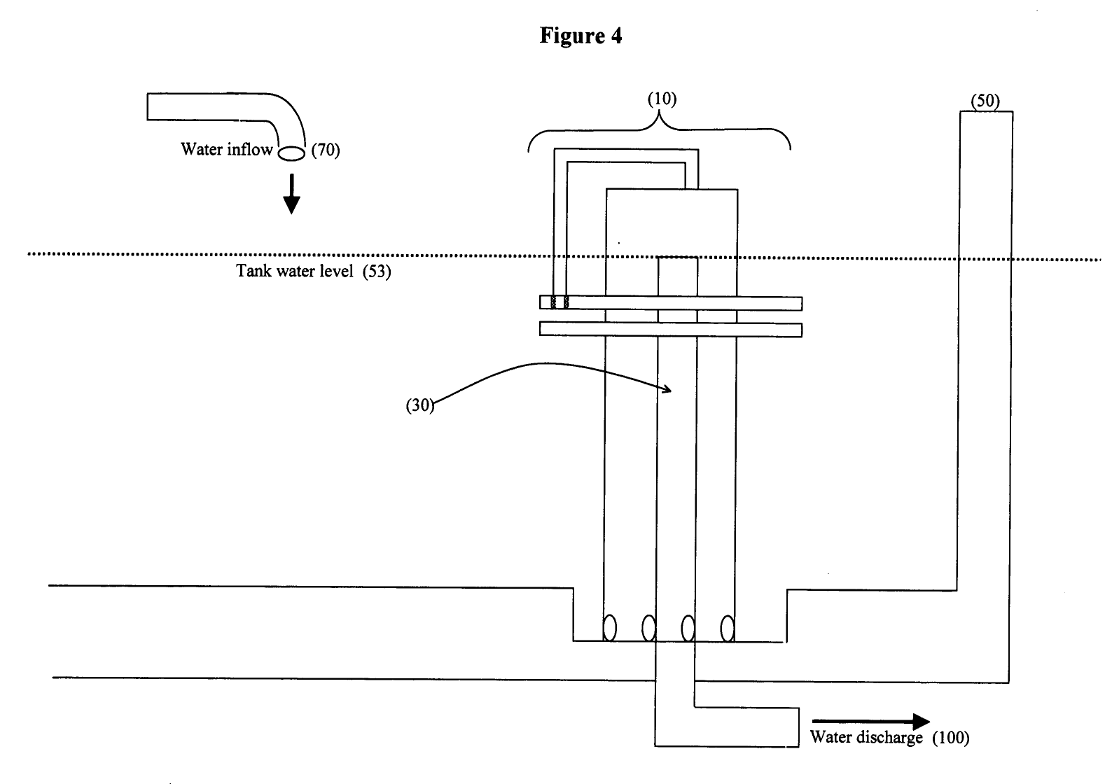

As shown in FIG. 4, the tank remains in fill phase until the fluid level 53 reaches the level of the opening of the standpipe 30. Once the fluid level reaches the standpipe opening, it begins to trickle into the standpipe and the system enters the trickle phase. In trickle phase, the fluid level continues to rise because the rate of inflow exceeds the capacity of the fluid to exit via the standpipe. At this phase, turbulence is created at the standpipe opening. The fluid is occluded at this point and the fluid level in the interstitial space continues to rise.

As the fluid level continues to rise, a head pressure builds in the interstitial space above the standpipe. When this head pressure exceeds the resistance created by the turbulence at the standpipe opening, the occluded fluid flows down the standpipe, flooding it, and a siphon is created. The fluid level in the system begins to drop, and the system is then in the flush phase. Flush phase continues until the fluid level reaches the siphon break level, at which point the process begins again. During flush phase, a percentage of the total volume of the tank is flushed, which can be adjusted by varying the height of the siphon break tube opening.

The fluid handling system of the present invention creates a continuous ebb and flow of the fluid contained in the system, which has particular advantages in aquatic ecosystems and most particularly for Xenopus frogs used in biological research. Xenopus frogs produce solid waste, which needs to be removed from the tanks for the continued good health of the captive frogs. This waste is generally denser than water and thus sinks to the bottom of the tank.

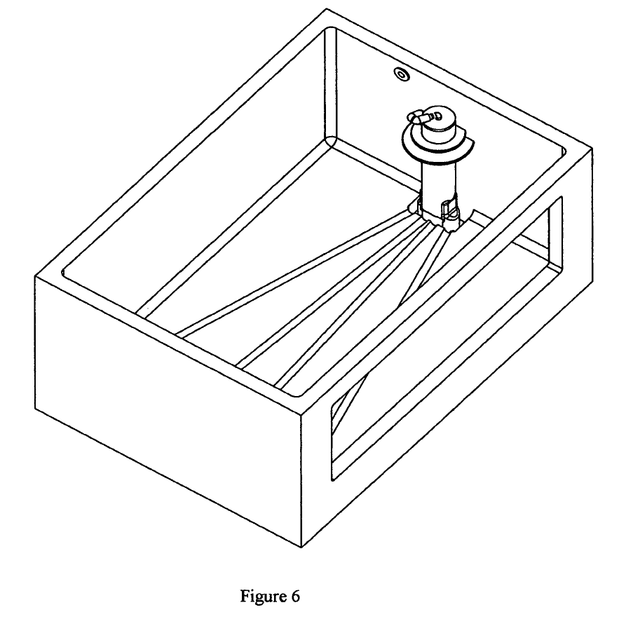

The tank design can be optimized to work with the ebb and flow drain to achieve efficient removal of the solid waste. For example, as shown in FIG. 6, the bottom of the tank 50 can be manufactured to have directional channels, which direct the flow of water, and thus the waste, toward the drain assembly 10. The directional flow of the water toward the drain assembly can be further enhanced by placing the fluid returns on the bottom of the tank, away from the drain assembly. Multiple fluid returns aid the directional flow further.

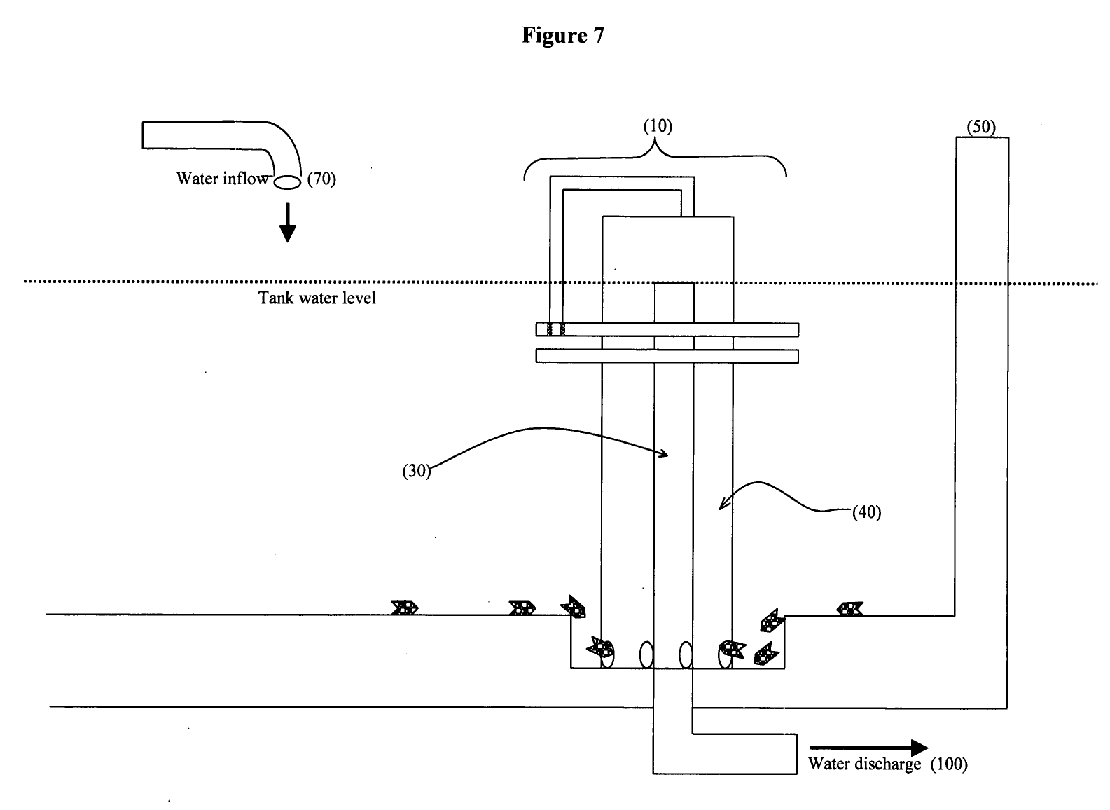

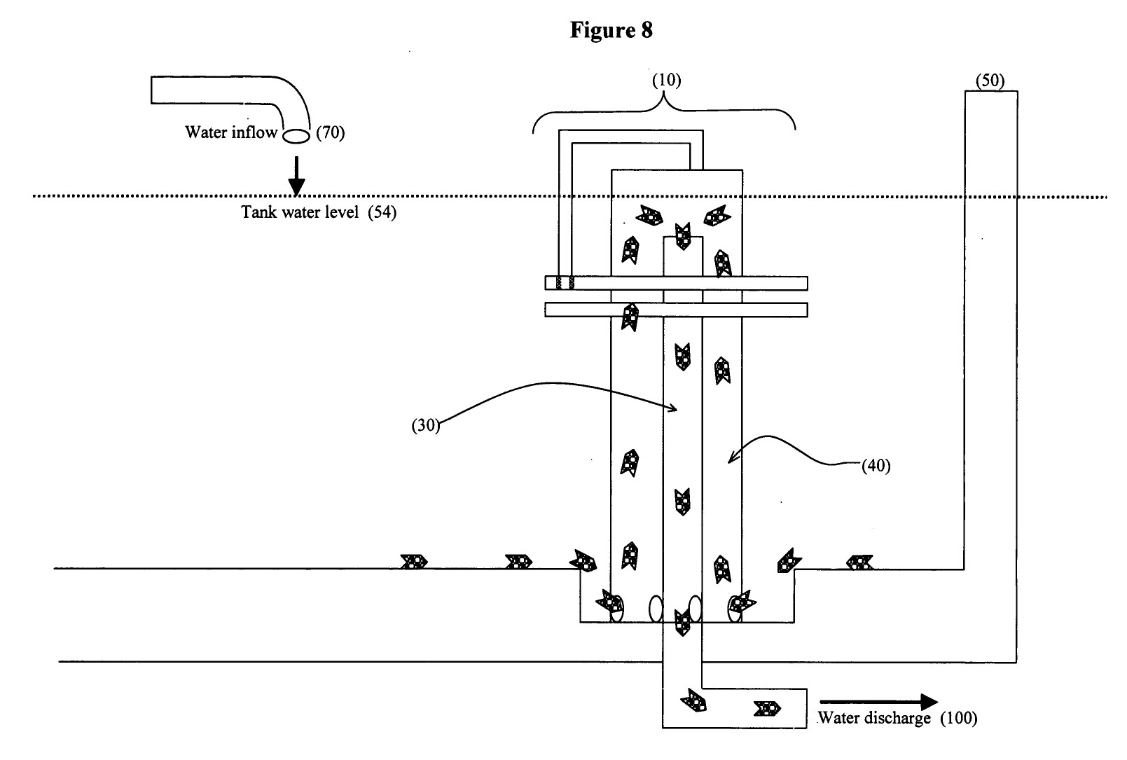

During trickle phase, the capacitance of the water in the interstitial space is approximately 3 cm/s. This capacitance combined with the directional flow of the water along the bottom channels of the tank causes the solid frog waste to collect at the base of the drain assembly. In a most preferred embodiment, as shown in FIG. 7, the drain is set in a recessed portion 55 of the tank 50. The solid waste then collects in the recessed portion of the tank. During flush phase, the capacitance of water in the interstitial space increases approximately 5-6 fold to around 18 cm/s. This capacitance is sufficient to carry the solid waste from the bottom of the drain assembly to the top and out of the standpipe, as shown in FIG. 8.

I claim:

1. A drain assembly comprising:
a. an inner standpipe;
b. an outer housing, having a proximal and a distal end, placed over the inner standpipe to create an interstitial space between the standpipe and the outer housing;
c. the outer housing having an at least one aperture at the proximal end that connects to a siphon-break tube; and
d. the outer housing having at least one port for fluid communication between the exterior of the outer housing and the interstitial space between the outer housing and the inner standpipe.

2. The drain assembly of claim 1, wherein the height of the siphon-break tube is adjustable.

3. A tank assembly comprised of:
a. a tank and a drain;
b. wherein the drain is comprised of an inner standpipe; an outer housing, having a proximal and a distal end, which is positioned over the inner standpipe to create an interstitial space between the standpipe and the outer housing; the outer housing having an at least one aperture at the proximal end that connects to a siphon-break tube; and the outer housing having at least one port for fluid communication between the exterior of the outer housing and the interstitial space between the outer housing and the inner standpipe; and
c. the tank is comprised of a fluid holding reservoir.

4. The tank assembly of claim 3, wherein the tank has a recessed portion to receive the drain.

5. The tank assembly of claim 3, wherein the bottom of the tank has flow-directing channels directed toward the drain

6. The tank assembly of claim 5, wherein the tank assembly has a fluid return on the bottom of the tank.

7. The tank assembly of claim 6, wherein the fluid return contains multiple return ports.

8. The tank assembly of claim 7, wherein the multiple fluid return ports are aligned with the flow-directing channels.

9. A fluid-handling system comprised of:
a. a fill phase, a trickle phase and a flush phase, wherein;
b. during the fill phase, the fluid-handling system is equalized with respect to atmospheric pressure and the system begins to fill until the fluid reaches a fluid egress;
c. upon reaching egress, the system enters the trickle phase, wherein the fluid begins to trickle from the system until the capacity of the egress is exceeded and occlusion forms causing a head pressure to build above the fluid egress; and
d. wherein the head pressure exceeds the pressure created by the occlusion, the fluid begins to flow, forming a siphon, entering the flush phase.

10. The fluid-handling system of claim 9 wherein the siphon ends when the fluid level falls below the level of an opening to atmosphere.

11. The fluid-handling system of claim 10, wherein a total volume of fluid is flushed from the system depending on the variably adjusted height of the opening of the system to the atmosphere.

12. The fluid-handling system of claim 9, wherein the capacitance of the fluid during the flush phase is approximately at least three times the capacitance of the fluid during trickle phase.
